(19) United States
(12) Patent Application Publication
(10) Pub. No.: US 2013/0189384 A1
(43) Pub. Date: Jul. 25, 2013

(54) METHODS AND DEVICES FOR PREPARING CUSTOMIZED BOWLING BALL FINGER SLEEVES

(71) Applicant: Frank Lamoso, Deltona, FL (US)

(72) Inventor: Frank Lamoso, Deltona, FL (US)

(21) Appl. No.: 13/358,052

(22) Filed: Jan. 25, 2012

(51) Int. Cl. B29C 43/34; A63B 43/00

(52) U.S. Cl. 425/2; 473/128; 264/319

(57) ABSTRACT

The subject invention pertains to methods and devices for manufacturing bowling ball finger sleeves that are customized to an individual ball and bowler. The method allows preparation of the finger sleeve directly in the finger hole of a bowling ball. The finger hole can be filled with a molding material and a finger inserted until the molding material cures and retains the shape of the inserted finger. Further embodiments include the use of a protective ring to prevent damage to the outer edge of the finger sleeve and preparation of vents within the sleeve to provide room for expansion of the bowler's finger.

### BACKGROUND OF INVENTION

Bowling is a popular sport enjoyed by men, women, and children of all ages. To be a good bowler requires not only skill and practice, but proper equipment. Serious bowlers often invest in their own equipment to improve their skill, technique, and enjoyment of the game. One of the most important pieces of equipment that a bowler can invest in is a bowling ball.

Bowling balls come in a large variety of sizes, weights, styles, and materials. There are several factors that must be examined when selecting the correct type of bowling ball, including individual bowler's skill, technique, type of lanes they typically bowl on, and other factors. One of the most important factors in selecting a ball is comfort and a properly fitted grip. A proper grip is essential to a proper, consistent ball release and can increase speed and revolutions. A proper grip can also make the ball seem lighter and can prevent injury.

Typically, a bowler's hands are measured against the chosen bowling ball and individual finger holes are drilled into a bowling ball to match the bowler's finger position and span for that particular ball. Finger inserts can also be inserted in the holes to further improve grip and provide more consistency in feel. However, most finger inserts are generically made of a pliable material to accommodate a variety of finger and thumb sizes, and thus are not customized for each bowler. Some finger inserts can be customizable to each bowler, but the process usually requires a considerable amount of time and multiple steps. The process is often initiated by creating a mold of the bowler's fingers and thumb that can be used to create the inserts and multiple inserts thereafter. Often, such customized grips cannot be made entirely on-site. Thus, changes in the bowler's grip, finger size, skill, technique with a particular ball, etc. that may require new inserts will necessitate going through the process of creating a new mold, sending it to another location, waiting for the inserts to be returned, and inserting them into a bowling ball.

Further, some inserts are often designed to be removed and used with different bowling balls. But, repeated transfer of inserts between balls can affect the quality of the insert and the grip, particularly if it is not placed in precisely the same position in each ball. It can also be disadvantageous to transfer inserts between balls, since each ball can have slight differences in weight, density, diameter, etc. that were not accounted for when the insert was originally made.

There is a need in the art for finger inserts or a similar device that can be customized for individual bowlers and that are made for a specific ball. Ideally, the customizable finger inserts can be made quickly, on site, and relatively inexpensively.

### BRIEF SUMMARY

The embodiments of the subject invention are directed to a method of manufacturing a finger sleeve for bowling balls that can be fully customized to an individual. Advantageously, the finger sleeves of the subject invention can be made quickly and easily, and if desired on-site with the bowling ball. A further advantage is that they can be made for a specific bowling ball. The subject invention successfully addresses the above described disadvantages associated with the previously known devices and methods, and provides certain attributes and advantages, which have not been realized by these known devices.

In one embodiment, a pliable molding material is injected into one or more existing finger holes in a bowling ball. The bowler can then insert one or more fingers and/or thumb into the respective finger holes and hold the ball in a natural position. By maintaining the hold for a period of time, the molding material will “set” or solidify (also referred to as “curing”) around the bowler's fingers and form finger holes that precisely match the contours and features of the bowler's fingers.

Further embodiments include a protective ring around the edge of the finger hole to protect the edges of the finger sleeve and devices and methods for providing venting of the finger sleeve to facilitate release of the ball and accommodate changes in a bowler's finger size or position.

Other embodiments and further scope of applicability of the present invention will become apparent from the detailed descriptions given herein; it should be understood, however, that the detailed descriptions, while indicating preferred embodiments of the invention, are given by way of illustration only, since various changes and modifications within the spirit and scope of the invention will become apparent from such descriptions.

### BRIEF DESCRIPTION OF DRAWINGS

In order that a more precise understanding of the above recited invention can be obtained, a more particular description of the invention briefly described above will be rendered by reference to specific embodiments thereof that are illustrated in the appended drawings. The drawings presented herein may not be drawn to scale and any reference to dimensions in the drawings or the following descriptions are specific to the embodiments disclosed. Any variations of these dimensions that will allow the subject invention to function for its intended purpose are considered to be within the scope of the subject invention. Thus, understanding that these drawings depict only typical embodiments of the invention and are not therefore to be considered as limiting in scope, the invention will be described and explained with additional specificity and detail through the use of the accompanying drawings in which:

FIG. 1 shows one embodiment of the devices and methods of preparing a finger insert of the subject invention.

FIG. 2 is a photograph illustrating the injection of molding material into a bowling ball first finger hole.

FIG. 3 is a photograph illustrating that the molding material can be injected up to the edge of a bowling ball finger hole.

FIG. 4 is a photograph illustrating the injection of molding material into a bowling ball second finger hole.

FIG. 5 is a photograph illustrating first and second bowling ball finger holes filed with molding material.

FIG. 6 is a photograph illustrating insertion of a first and second finger into a first and second bowling ball finger hole filed with molding material. Note excess material being extruded from the top of the finger holes.

FIG. 7 is a photograph illustrating the removal of a first and second finger from a first and second bowling ball finger hole after molding material has cured or hardened. It can be seen in this photograph that the fingers can be pulled generally parallel to the finger hole to remove them without damage to the cured molded material.

FIG. 8 is a photograph illustrating first and second bowling ball finger holes containing molded finger inserts.

FIG. 9 is a photograph illustrating one method of removing excess molding material from the surface surrounding the bowling ball finger holes. In this method, an implement with a sharp blade is used to cut away the excess cured molding material.

FIG. 10 is a photograph illustrating how the excess cured molding material shown in FIG. 8 is cleanly removed to the surface level of the bowling ball.

FIG. 11 is a photograph illustrating how a first and second finger can be re-inserted into the completed molded finger inserts.

FIG. 12 is a photograph illustrating the injection of molding material into a bowling ball thumb hole.

FIG. 13 is a photograph illustrating that the molding material can be injected up to the edge of a bowling ball thumb hole.

FIG. 14 is a photograph illustrating insertion of a thumb into a bowling ball thumb hole filed with molding material. Note excess material being extruded from the top of the thumb hole.

FIG. 15 is a photograph illustrating a bowling ball thumb hole containing a molded thumb insert.

FIG. 16 is a photograph illustrating one method of removing excess molding material from the surface surrounding the bowling ball thumb hole. In this method, an implement with a sharp blade is used to cut away the excess molded material.

FIG. 17 is a photograph illustrating a bowling ball having molded finger and thumb inserts.

FIG. 18 is a photograph illustrating how, in one embodiment, an adhesive can be applied between the surface of the bowling ball finger hole and the exterior surface of a molded finger and/or thumb insert. Note how the molded finger/thumb sleeve is temporarily pulled away from the surface of the bowling ball finger/thumb hole so that adhesive can be applied along a greater surface area to ensure that the sleeve does not change position during use.

### DETAILED DISCLOSURE

The subject invention describes embodiments of methods and devices for manufacturing bowling ball finger grips. More specifically, the subject invention provides one or more embodiments of a method for manufacturing customized finger grips within a bowling ball.

The following description will disclose that the subject invention is particularly useful in the sport of bowling, in particular for the customization of bowling balls. However, a person with skill in the art will be able to recognize numerous other uses that would be applicable to the devices and methods of the subject invention. While the subject application describes, and many of the terms herein relate to, a use for customizing bowling ball finger holes, other modifications will be apparent to a person with skill in the art, having benefit of the subject disclosure. Such modifications and alternative uses are contemplated to be within the scope of the present invention.

As used in the following description of the invention, the terms “finger”, “finger hole”, or “finger insert” are used generally and are intended to include reference to the thumb, i.e., as being equivalent to a “digit.”

The present invention is more particularly described in the following examples that are intended to be illustrative only since numerous modifications and variations therein will be apparent to those skilled in the art. As used in the specification and in the claims, the singular for “a,” “an” and “the” include plural referents unless the context clearly dictates otherwise.

Reference will be made to the attached figures on which the same reference numerals are used throughout to indicate the same or similar components. With reference to the attached figures, which show certain embodiments of the subject invention, it can be seen that the subject invention comprises devices and method for manufacturing a finger sleeve for a bowling ball 2. More specifically, the subject invention provides devices and methods for manufacturing customized finger inserts 3 for bowling balls. Advantageously, the custom inserts manufactured with the devices and by the methods disclosed herein provide a more comfortable grip on a bowling ball, can increase precision and skill, and reduce injury. A further advantage can be realized with the use of one or more vents or voids within a finger sleeve that can accommodate slight changes in the shape or diameter of a finger.

There is a variety of materials that can be utilized for the manufacture of a customized finger sleeve of the subject invention. Ideally, the properties of the material utilized allow it to be injected, pressed, poured, or otherwise disposed within a finger hole of a bowling ball and further conform to the shape of an object, such as a finger, inserted therein. It can be advantageous for such molding material to be biocompatible, anti-allergenic, bioinert, or otherwise non-reactive to human skin or tissue. An ideal material will also be one that can solidify or “cure” to a predetermined firmness or rigidity within a relatively short amount of time. Ideally, such molding material will cure within approximately 2 minutes to approximately 30 minutes. More ideally, such molding material will cure within approximately 2 minutes to approximately 15 minutes. In a specific embodiment, the molding material utilized will cure in approximately 4-5 minutes.

Different materials cure to different levels of firmness or softness and the selection of which one or more materials to use for a finger insert can depend upon the preferences of the bowler, the material of the bowling ball, firmness of the bowler's grip, desired longevity of the finger insert, and other factors known to those with skill in the art. Further, such molding material(s) can be of various colors and/or can include one or more additive materials that affect the appearance or texture of the material, such as, by way of non-limiting example, glitters, textural beads or sands, various fibers, photoreactive chemicals, and the like, can all be added to a molding material.

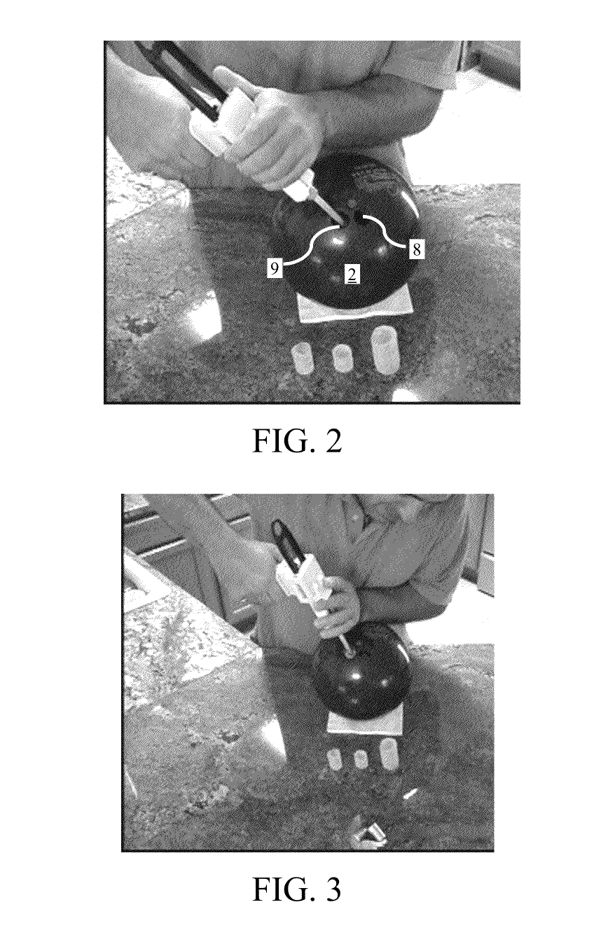

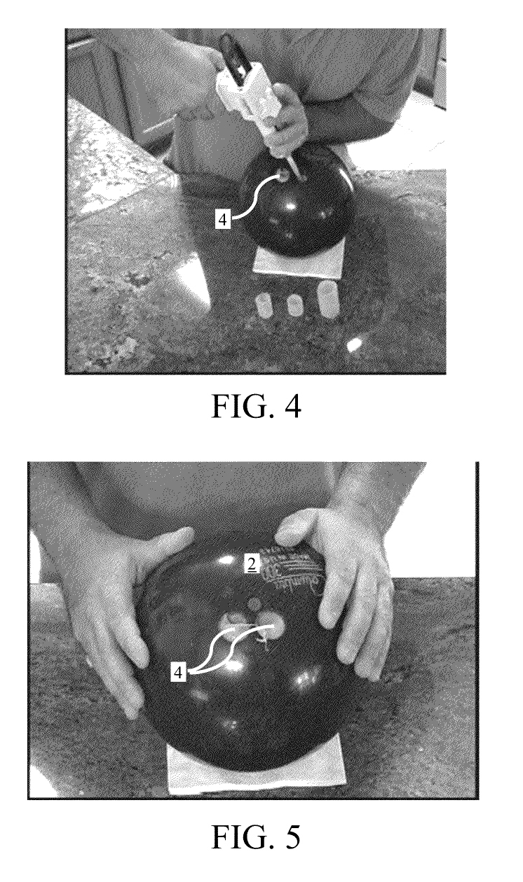

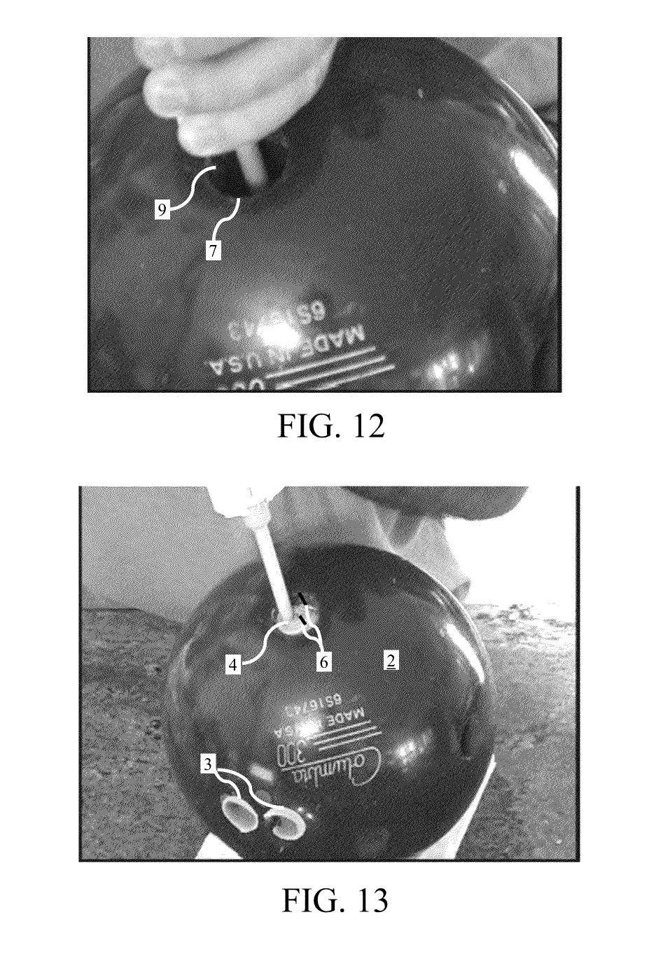

There are currently several materials known in the art that can be suitable as molding materials 4 for the subject invention. For example, polyvinylchloride (PVC) is a standard soft vinyl material commonly used in making anatomical molds. PVC can be formulated to cure to a wide range of rigidities, from a hard solid to a soft, pliable material. Silicone is another example of a material that can be utilized with the methods of the subject invention. It can be formulated to cure to different rigidities as well, including a soft, pliable material. Silicone is also available in biocompatible, hygienically pure, and medical grade formulations. All of these materials are available in cartridges that can be used with an injector gun, such as shown in FIGS. 2, 4, 12 and 13. Other materials than those listed above can also be utilized to manufacture a finger sleeve of the subject invention. The selection of which of one or more materials to utilize is within the skill of a person trained in the art. Such variations in materials are considered to be within the scope of the subject invention.

Typically, finger holes 8 are drilled into a bowling ball and the resulting wall surface 9, if necessary, is polished or sanded to provide a smooth finish to reduce irritation. The embodiments of the methods of the subject invention can be used with existing holes in a bowling ball. Alternatively, the finger holes can be drilled to a larger diameter to accommodate more of the molding material being utilized there within. Finger holes are typically drilled with a circular circumference, but can be drilled with an oval or other non-circular circumference. Advantageously, the methods and devices of the subject invention can be utilized with any size or shape of finger hole.

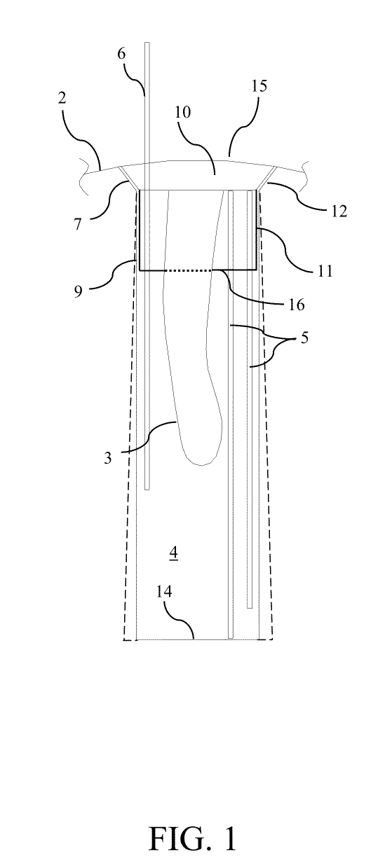

Because the finger hole wall surfaces are often polished to a smooth, non-irritating finish, there can be little or no stiction or purchase between a molding material and the polished wall surfaces. This can make it difficult for a customized finger sleeve of the subject invention to remain in place within a finger hole. In one embodiment, a finger insert is prepared in the finger hole prior to being sanded or smoothed. However, the need for a finger insert may not be realized until the finger hole is smoothed and the ball has been used in play. Thus, it may be necessary to prepare a finger insert after the finger hole is smoothed. In an alternative embodiment, the wall surface of a finger hole is roughed or scored to increase the stiction and/or purchase between a molding material and the wall surface. In another alternative embodiment, the hole is drilled into a frusto-conical shape, such as shown with dotted lines in FIG. 1, wherein the diameter at the bottom 14 of the hole is larger and decreases towards the top 15 of the hole. This provides a customized finger sleeve with a plug-like effect that can reduce or prevent it from being pulled out of the finger hole. In a still further embodiment, the finger hole can be both roughened or scored and drilled to achieve the above-described plug-like effect. This can provide the advantage of securing the customized finger plug within the finger hole and reducing or preventing rotation of the plug within the hole.

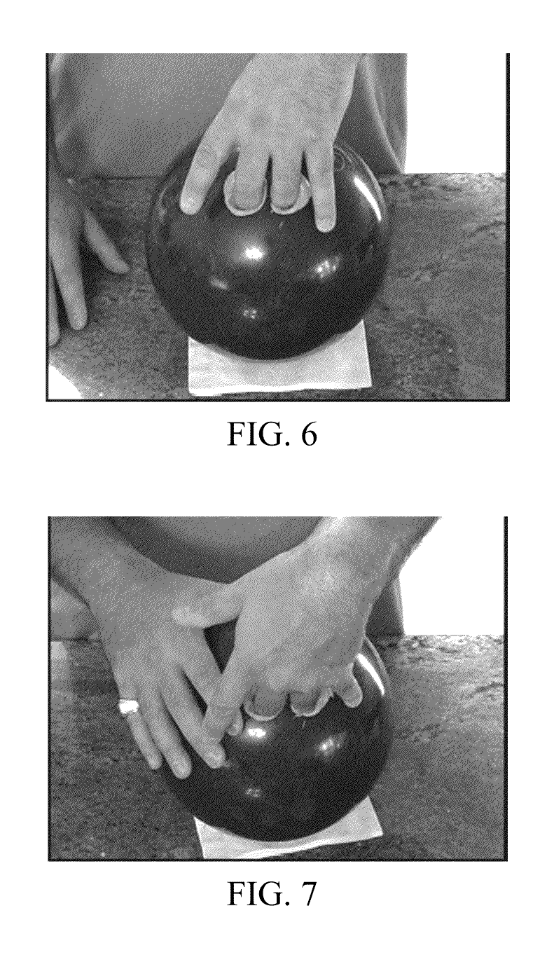

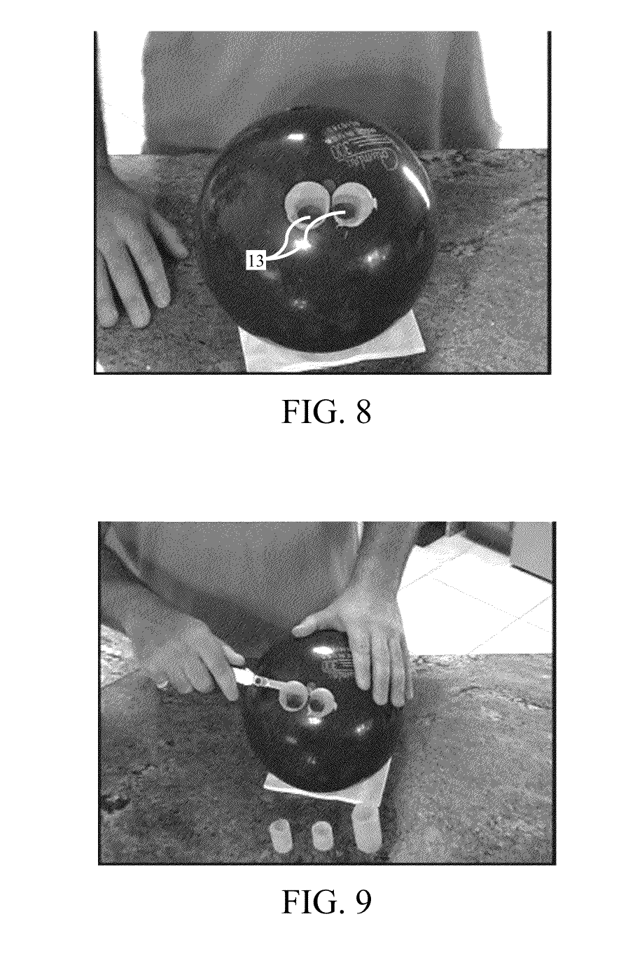

Once the finger hole is sufficiently filled with molding material, a finger can be inserted. To ensure that the size and shape of the finger hole are compatible with the position of the finger and hand during ball presentation, it can be beneficial for the person to place their hand on the bowling ball as they would when actually bowling. Once the finger and hand are properly placed it should be maintained as still as possible to allow the molding material to conform to the contours of the finger. FIG. 6 illustrates this process. As discussed above, this can take a few minutes and, in a specific embodiment, the molding material will set in about 4-5 minutes sufficiently for the finger to be removed without affecting the molding material. Once the material is set, the finger can be removed by gently pulling the hand generally parallel to the finger hole, as shown, for example, in FIGS. 7 and 8. Removal of the finger will leave a void 13, see FIG. 8 for example, into which the same finger can be re-inserted numerous times.

It is not uncommon for a person's fingers to change in size, even over the course of one day. This can be due to diet, hydration, level of activity, or other factors. A bowler's fingers often swell, especially after bowling several games. As such, it is not uncommon for the finger holes of a bowling ball to begin to feel tight or restrictive during play time. Advantageously, the customized finger inserts of the subject invention can allow for some expansion of finger size, thus reducing or eliminating the tightness, discomfort, and possible loss of accuracy or skill that can occur during play.

However, in some circumstances an individual's fingers may swell more than normal. There can also be other instances when additional pressure is applied to the wall surface of a finger hole, such as, for example, with different styles of ball presentation or changes in posture. In such instances it can be beneficial for a finger sleeve 3 to have additional pliability or flexibility, to absorb such excess pressure.

In one embodiment, the method includes the placement of one or more elongated rods 6 around the periphery of the molding material, after it is disposed within the finger hole. FIGS. 1 and 13 illustrate examples of a finger hole with molding material rods in place. Finger rods can be inserted just prior to a finger being inserted for molding or after a finger is inserted. Ideally, the rods 6 are placed so as not to interfere with the natural gripping or holding posture. This will ensure accurately customized finger sleeves. More ideally, the rods will be placed so that there is sufficient molding material between the rods, the wall surface, and the inserted finger. Once the molding material has cured, the rods can be extracted from the molding material the same way a finger is, by pulling parallel to the finger hole 8. If necessary, the rods and/or a finger can be coated with a substance, such as, for example, oils, lotions, creams, or similarly friction reducing products, that facilitate removal of the rods and/or finger from the molding material.

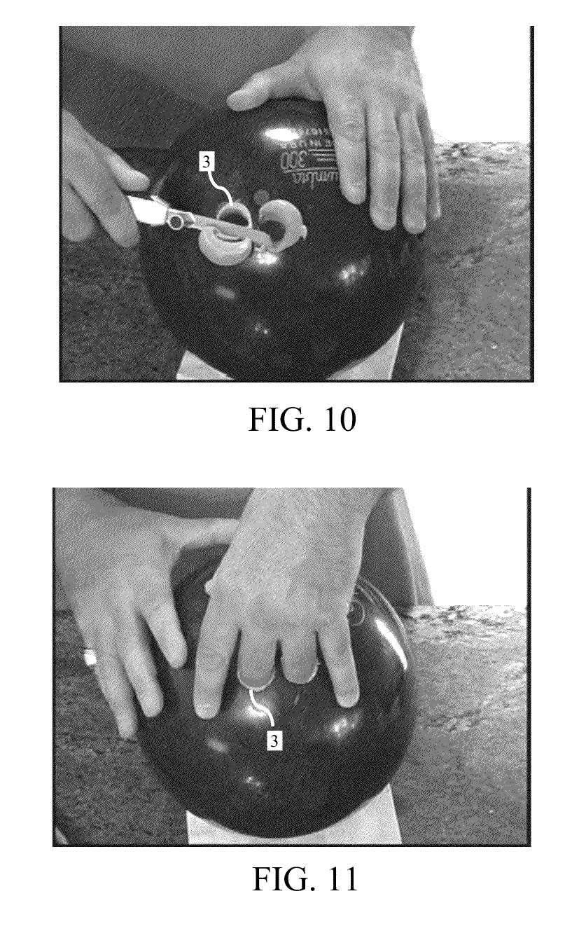

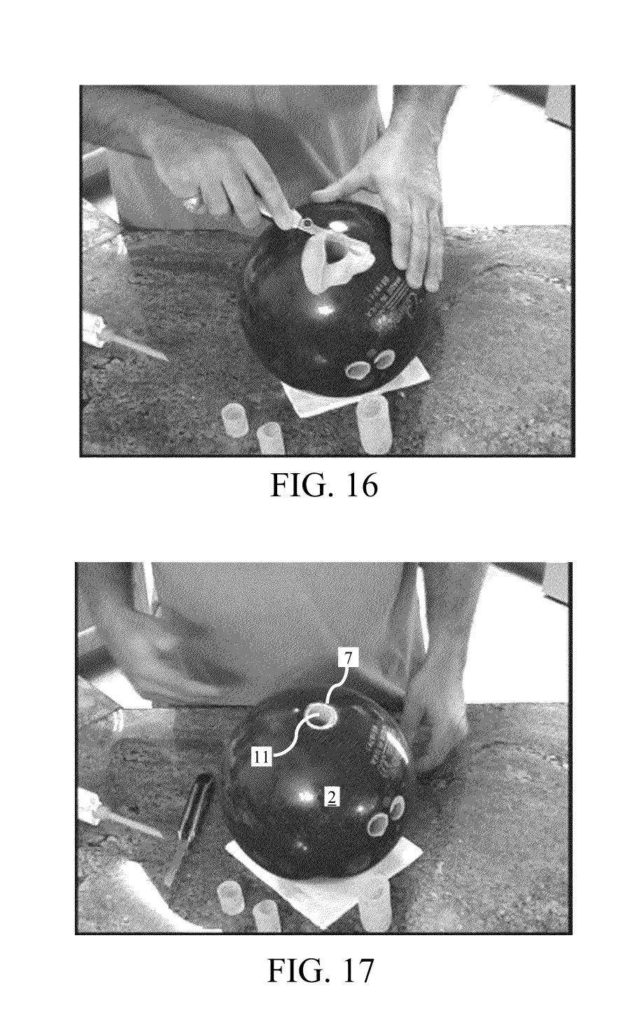

After the molding material is set and the finger and/or rods have been removed, there can be excess molding material around the outer edge of the finger hole that was extruded when the finger and rods were inserted, as illustrated in FIGS. 6, 14, and 15. This excess material can be removed by use of a sharp implement or blade to cut or saw the excess material flush with the surface of the ball, as shown, for example, in FIGS. 9, 10, 16, and 17. Other methods and devices can also be utilized, as known to those with skill in the art, to remove excess molding material from the surface of the ball.

When a finger hole is drilled into a bowling ball, the outer edge 7 can be rather sharp, as shown, for example, in FIG. 11. This edge is often lightly sanded to make it less abrasive. When a standard finger insert is utilized, an inserted finger usually does not make contact with the outer edge. Instead the finger slides over the finger insert. This can result in increased pressure and friction being applied to the upper edge 11 of the finger insert, or that portion nearest the outer edge 7, as shown in FIG. 17. As such, a finger insert is usually made of a durable, but flexible material that can withstand the wear and tear of repeated use. Typically, the useful life of a finger insert is about 6-7 months, before it needs to be replaced.

The advantage of the finger sleeve 3 of the subject invention is that it can utilize a softer material that conforms more closely to the contours of a finger. However, such materials can also be less durable that the typical finger insert, particularly where the finger compresses it against the wall surface 9 or along the outer edge 7. In a further embodiment, a protective ring 10 can be utilized on and/or around the outer edge to reduce wear and tear on a finger sleeve. FIG. 1 illustrates an embodiment of a protective ring of the subject invention. A protective ring 10 can surround the outer edge 7 of the finger hole 8 and provide a surface against which a finger, exiting the hole, can slide. The protective ring can also extend a sufficient distance into the hole, and conform to the wall surface, to ensure that excessive finger pressure is only exerted on the protective ring. FIG. 1 illustrates an embodiment of a protective ring positioned within a bowling ball opening to protect the upper edge. The protective ring can be made of one or more materials that can withstand repeated use. The protective ring can also be made of one or more materials that have a low coefficient of friction against human skin, so that it does not inhibit finger release.

In one embodiment, the outer edge 7 of a bowling ball 2 is formed to have an angle or shape that interdigitates with the shape of a protective ring 10. When the protective ring is placed around the outer edge, they can form a complementary attachment, such that the surface of the protective ring is flush with the surface of the ball, forming a smooth, uniform surface. In one embodiment, the interdigitating shape, or other structural features incorporated into the hole, outer edge, or protective ring are able to hold the protective ring in place against the outer edge. In one embodiment, the finger hole and/or the outer edge and protective ring are configured with complementary screw threads, such that the protective ring can be screwed into the hole and/or around the outer edge. In an alternative embodiment, the hole can be configured with a groove and the protective ring can include one or more pawls or biased teeth that can fit into the groove, holding the protective ring in place, when disposed over the outer edge. In another alternative embodiment, the protective ring, the finger hole, and the outer edge can be configured and sized to provide an interference fit between them, which can hold the finger sleeve in place, as shown, for example, in FIG. 1. In a further embodiment, an adhesive, cement, or other adhering product is utilized to hold the protective ring against the outer edge.

In a specific embodiment, the outer edge 7 of a bowling ball 2 is beveled 12 to an angle of between approximately 35° and 55°, an example of which is shown in FIG. 1. The protective ring can also have a beveled edge that is complimentary to the bevel 12 of the outer edge. When the protective ring is placed on the outer edge, the complementary angles allow the protective ring to be disposed below or flush with the surface of the bowling ball.

The advantage of the finger sleeve of the subject invention is that it can be made directly within the finger hole of a bowling ball. Therefore, not only can it conform to the shape of a finger placed therein, but it can conform to the shape and contours of the finger hole. However, to ensure that the finger sleeve does not come out of the hole unintentionally or rotate position within the hole, one or more adhesives can be used to secure the finger sleeve against the side of the finger hole and/or the outer edge.

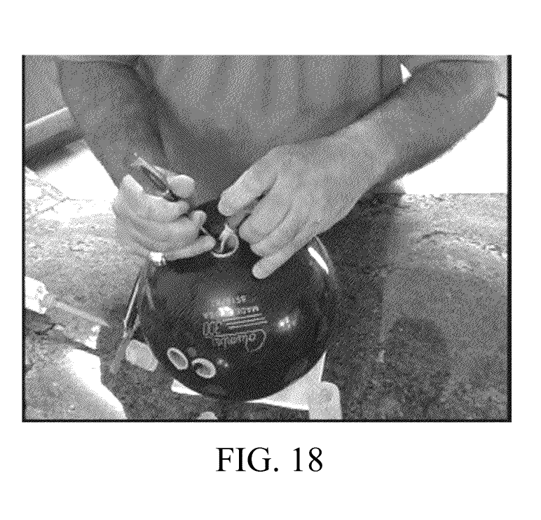

In one embodiment, the upper edge 11 of the finger sleeve 3 is carefully moved away from the wall surface 9, as demonstrated in FIG. 18. The upper edge 11 can include a portion of the sleeve between approximately 0.5 inch and approximately 1.5 inch from the outer edge or from the surface of the ball. Once the upper edge has been moved away from the wall surface, any type of appropriate adhesive device or substance can be presented between the finger sleeve and the wall surface. One example of an adhesive that is commonly used with finger inserts, and can be used with a finger sleeve of the subject invention, is cyanoacrylate (Superglue) or a similar polymer adhesive. The finger sleeve can then be moved back to the original position, allowing the adhesive to hold it in place against the wall surface. This process can be repeated as many times as necessary around the periphery of the upper edge of the finger sleeve until sufficient adhesive is applied.

Following is an example that illustrates procedures for practicing the subject invention. These examples are provided for the purpose of illustration only and should not be construed as limiting. Thus, any and all variations that become evident as a result of the teachings herein or from the following examples are contemplated to be within the scope of the present invention.

### Example 1

### Method of Preparing a Finger Sleeve within a Bowling Ball

The initial step of preparing a finger sleeve is the preparation of a bowling ball finger hole. The finger hole should be clean and free of any chemicals, oils, powders, etc. Depending upon the material of the ball, the smoothness of the finger hole wall surface, and other factors that would be understood by a person skilled in the art, it may be advisable to sand the finger hole wall surface to a rough finish, to facilitate adherence of the molding material.

Once the finger hole is prepared, it can be filed with the molding material. FIGS. 2, 3, 4, 5, 12, and 13 illustrate this process. The molding material utilized is a flexible silicone material, similar to the types of impression material used to create ear molds for preparation of medical appliances, such as hearing aids. Several products currently on the market can be utilized, such as, by way of example only, Flextime, Gold Velvet, XL100, XL200, or XL300 silicones, as well as an injector gun for extruding the products (available from All American Mold Laboratories, Inc., Oklahoma City, Okla.). The amount of material utilized will depend upon the size of the finger hole, but usually between approximately 2 ounces to approximately 7 ounces of molding material are required. More or less molding material can be used if necessary.

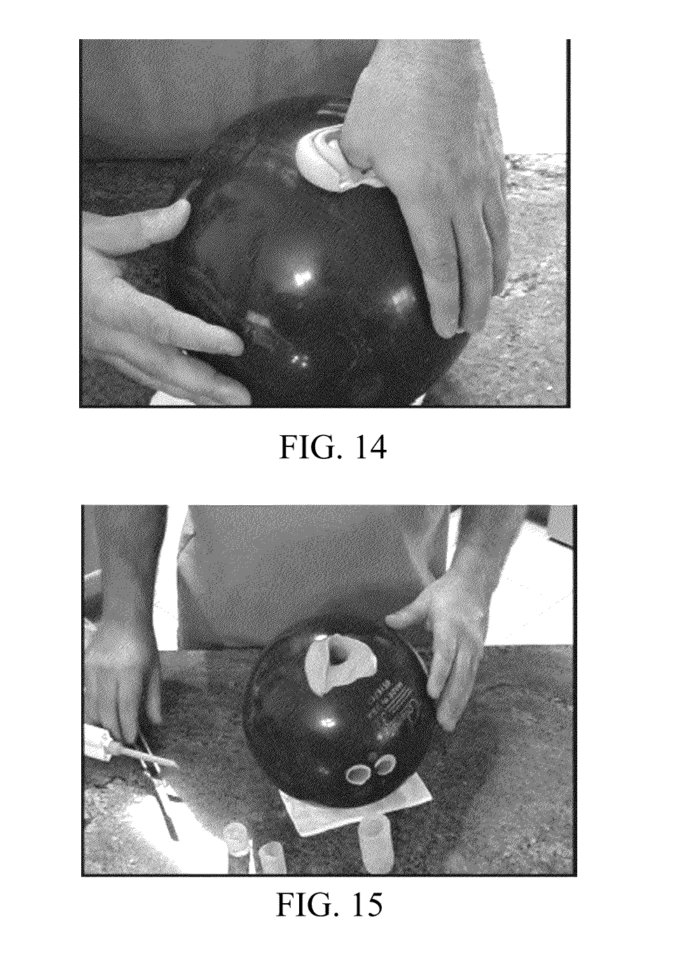

After the finger hole is filed with molding material, an individual can insert their finger into the finger hole. FIGS. 6 and 14 illustrate this step. Ideally, one would hold the ball in a normal fashion, not necessarily trying to assume a gripping or presentation posture. Since a bowler's grip can change, it can be better to form the finger sleeves so that they conform to natural holding position. Alternatively, the entire hand can be positioned as it would be when gripping the ball for presentation. This can ensure that the fingers are in the most comfortable position for bowling. The fingers and hand should be kept in the desired position and as still as possible for approximately 5-7 minutes while the molding material cures or sets to the desired shape. While not usually necessary, if desired, the fingers and hand can be covered with a light coating of oil, lotion, or other product to ease release of the finger from the molding material.

If vents are desired, one or more rods can be inserted into the molding material around the periphery of the finger hole, soon after the finger is inserted. Again, if necessary, the rods can be coated with oil or other substance that can facilitate removal from the molding material. The rods can be inserted to any desired depth within the hole, and are preferably not in direct contact with the finger. FIG. 1 shows an example of rods being used in a finger sleeve.

Once the molding material is set, the rods, if used can be withdrawn by pulling parallel to the hole. Likewise, the finger can be removed, either before or after the rods are withdrawn, by pulling the finger generally parallel to the finger hole, as illustrated in FIG. 7. Any excess material that extruded from the finger hole can be cut away by passing a sharp implement along the surface of the bowling ball. FIGS. 8, 9, 10, and 16 illustrate this step of the process.

To ensure that the entire column of finger material has set properly and is secured within the finger hole, it can be beneficial to allow the finger material to cure for an additional few minutes. Usually between approximately 5 minutes to approximately 10 minutes of additional curing time will ensure that the finger sleeve is properly set. After that time, the finger insert is ready to be used and will have a useful lifespan of approximately 5-7 month before it should be replaced.

### Example II

### Installation of Protective Ring

Prior to preparation of a finger insert, the outer edge of the finger hole is shaved or sanded to have a beveled edge of approximately 45°. Following the procedure in Example 1, a finger insert is created within the finger hole. Once the molding material has fully cured and the finger and/or rods have been removed, the excess material can be removed from the surface of the ball.

To accommodate the protective ring, additional material within the finger hole can be removed to expose the beveled edge, if necessary. As described in Example 1, the finger insert can be secured against the wall surface with an adhesive. A protective ring having a compatible shape to the beveled edge can be placed within the finger hole. If the protective ring extends into the finger hole and past the beveled edge portion, it may be necessary to remove additional material below the beveled edge to accommodate the protective ring. Once the protective ring is in place, it can be secured with an adhesive against the wall surface.

Any reference in this specification to “one embodiment,” “an embodiment,” “example embodiment,” “further embodiment,” “alternative embodiment,” etc., is for literary convenience. The implication is that any particular feature, structure, or characteristic described in connection with such an embodiment is included in at least one embodiment of the invention. The appearance of such phrases in various places in the specification does not necessarily refer to the same embodiment. Further, when a particular feature, structure, or characteristic is described in connection with any embodiment, it is within the purview of one skilled in the art to affect such feature, structure, or characteristic in connection with other ones of the embodiments.

The invention has been described herein in considerable detail, in order to comply with the Patent Statutes and to provide those skilled in the art with information needed to apply the novel principles, and to construct and use such specialized components as are required. However, the invention can be carried out by specifically different equipment and devices, and that various modifications, both as to equipment details and operating procedures can be effected without departing from the scope of the invention itself. Further, although the present invention has been described with reference to specific details of certain embodiments thereof and by examples disclosed herein, it is not intended that such details should be regarded as limitations upon the scope of the invention except as and to the extent that they are included in the accompanying claims.

I claim:

1. A finger sleeve comprising:
molding material disposed and cured within a finger hole in a bowling ball, where the molding material extends from a bottom surface of the finger hole to at or about an outer edge of the finger hole and further has a void therein in the shape of a finger of an individual bowler.

2. The finger sleeve, according to claim 1, further comprising one or more vents formed into the molding material.

3. The finger sleeve, according to claim 1, further comprising a protective ring.

4. A method for manufacturing a finger sleeve in a bowling ball finger hole, said method comprising:
preparing the bowling ball finger hole;
disposing a curable molding material into the finger hole;
inserting a finger into the molding material in the finger hole;
maintaining the position of the finger in the molding material until the molding material cures;
removing the finger from the molding material.

5. The method, according to claim 4, further comprising removing excess material from the bowling ball finger hole.

6. The method, according to claim 4, further comprising,
inserting one or more rods into the molding material, before it has cured;

7. The method, according to claim 6, further comprising,
removing the one or more rods after the finger is removed from the molding material.

8. The method, according to claim 5, further comprising,
placing an adhesive between the molding material and the bowling ball finger hole.

9. The method, according to claim 8, further comprising,
securing a protective ring around the bowling ball finger hole.

10. A kit for manufacturing a finger sleeve comprising;
molding material for dispensing into a bowling ball finger hole, where the finger hole has an outer edge;
an adhesive for affixing the finger sleeve to the finger hole;
a protective ring for placement around the outer edge.

11. The kit, according to claim 10, further comprising a material for coating the finger before the finger is inserted into the molding material.

12. The kit, according to claim 10, further comprising, one or more rods to be placed around a finger inserted into the molding material in the bowling ball finger hole.

13. The kit, according to claim 10, further comprising an implement for removing excess molding material.
